(19) United States
(12) Patent Application Publication
(10) Pub. No.: US 2026/0206675 A1
(43) Pub. Date: Jul. 23, 2026

(54) BENT FERTILIZER KNIFE FOR DUAL SHANK SEEDING UNIT

(71) Applicant: Dutch Blacksmith Shop Ltd., Pilot Butte (CA)

(72) Inventors: Nicholas Alexander Volsky, Craven (CA); Jayden Gerald Raabel, Regina (CA)

(21) Appl. No.: 19/029,158

(22) Filed: Jan. 17, 2025

(51) Int. Cl. A01C 5/06; A01B 35/26; A01C 7/06

(52) U.S. Cl. CPC A01C 5/062; A01B 35/26; A01C 7/06

(57) ABSTRACT

A bent fertilizer knife is used with an agricultural dual shank seeding unit having a rear seed shank and a front fertilizer shank spaced forwardly of the rear shank. The fertilizer knife has (i) a knife body for mounting on the front shank, including an upright leading edge spanning a majority of a height of the knife, and (ii) a knife tip sloped downwardly and laterally outward from a bottom of the knife body such that a bottom of the knife tip is offset laterally from the upright leading edge of the knife body. The knife tip is offset laterally from the seed knife more than the upright leading edge of the knife body in an opposing lateral direction from a laterally sloped offset of the knife tip of the seed knife so as to increase seed and fertilizer separation while maintaining or improving crop residue flow.

### FIELD OF THE INVENTION

The present invention relates to a dual shank seeding unit of an agricultural implement including a leading fertilizer knife for forming a fertilizer receiving furrow in the ground and a trailing seed knife for forming a seed receiving furrow in the ground alongside the fertilizer receiving furrow, and more particularly the present invention relates to a configuration of the fertilizer knife in such a dual shank seeding unit.

### BACKGROUND

In agriculture, seeding implements typically comprise a frame including one or more toolbar sections, each supporting a plurality of spaced apart seeding units thereon. A common type of seeding unit includes both (i) a fertilize shank for supporting a fertilizer knife for forming a fertilizer furrow in the ground into which fertilizer is deposited and (ii) a seed shank rearwardly of the fertilizer shank for supporting a seed knife for forming a seed furrow in the ground alongside the fertilizer furrow into which seed is deposited. The bottom of the seed furrow receiving seed therein is separated from the bottom of the fertilizer furrow receiving fertilizer therein to maintain separation between the seed and fertilizer.

No-till seeding equipment using dual shank row units experience issues with crop residue flow and limited seed and fertilizer separation. Typical shank layouts have two vertical shanks separated by a horizontal distance, for example 1.5 inches such as dual shank row units by Vaderstad Industries Inc. and Seedmaster Manufacturing Ltd. Other shank layouts such as the John Deere 1870 Conserva Pak ® seeding unit by John Deere utilize an inline shank layout with a vertical fertilizer shank and an angled seed knife to achieve the same 1.5 inch horizontal separation of products. Crop residue will often catch and bunch between shanks, causing the toolbar to become plugged with residue. Increasing horizontal separation between the shanks often leads to even worse crop residue flow and increased plugging. Efforts to increase separation by increasing the vertical separation by lowering the fertilizer knife relative to the seed knife generally increases seed bed soil fracturing, reducing seed placement quality while significantly increasing draft force. The lower working depth of the leading shank also creates an increase in overall soil disturbance with increases in soil throw becoming a concern and limiting travel speed. Manufacturers have offered conversions for these units to change the shank layout to an inline configuration to improve crop residue flow through the seed drill, but the conversions limit the achievable seed to fertilizer separation.

### SUMMARY OF THE INVENTION

According to one aspect of the invention there is provided a fertilizer knife for a dual shank seeding unit of an agricultural seeding implement operated across ground in a forward working direction in which the dual shank seeding unit includes a rear shank supporting a seed knife for delivery of seed into the ground and a front shank spaced forwardly of the rear shank, the fertilizer knife comprising:

a knife body arranged for mounting onto the front shank, the knife body including an upright leading edge spanning a majority of a height of the fertilizer knife;

a knife tip extending downwardly from a bottom end of the knife body so as to be arranged to form a fertilizer furrow in the ground when operated in the forward working direction; and

a fertilizer passage having an outlet positioned rearwardly of the knife tip so as to be arranged for depositing fertilizer therethrough into the fertilizer furrow in the ground;

wherein the knife tip extends downwardly from the knife body at a laterally outwardly slope such that a bottom end of the knife tip is offset laterally from the upright leading edge of the knife body.

According to a second aspect of the present invention there is provided a dual shank seeding unit for an agricultural seeding implement arranged to be operated across ground in a forward working direction, the dual shank seeding unit comprising:

a rear shank arranged to be supported on the implement;

a seed knife supported on the rear shank including (i) a seed knife body for forming a seed furrow in the ground when operated in the forward working direction and (ii) a seed passage having an outlet positioned rearwardly of the seed knife tip for depositing seed therethrough into the seed furrow in the ground;

a front shank arranged to be supported on the implement at a location spaced forwardly of the rear shank; and

a fertilizer knife comprising (i) a fertilizer knife body supported on the front shank and including an upright leading edge spanning a majority of a height of the fertilizer knife, (ii) a fertilizer knife tip extending downwardly from a bottom end of the fertilizer knife body so as to be arranged to form a fertilizer furrow in the ground when operated in the forward working direction, and (iii) a fertilizer passage having an outlet positioned rearwardly of the fertilizer knife tip so as to be arranged for depositing fertilizer therethrough into the fertilizer furrow in the ground;

wherein the fertilizer knife tip extends downwardly from the fertilizer knife body at a laterally outwardly slope such that a bottom end of the knife tip is offset laterally from the upright leading edge of the fertilizer knife body.

The laterally outward slope of the fertilizer knife tip allows a significant increase in seed and fertilizer separation while maintaining a reduced horizontal distance or an inline shank relationship to maintain or improve crop residue flow. Horizontal separation can be adjusted by installing various knife tips with varying bend angles. The angled leading fertilizer knife reduces seed bed fracturing and can improve seed placement accuracy be creating less fractured, clearly defined fertilizer and seed furrows. Overall soil disturbance is maintained or reduced compared to conventional dual shank seeding units despite the increase in product separation.

Preferably the bottom end of the knife tip is arranged to be offset laterally from the seed knife more than the upright leading edge of the knife body.

When the seed knife includes a seed knife tip which is sloped downwardly and laterally outwardly in a first lateral direction, preferably the knife tip of the fertilizer knife is sloped downwardly and laterally outwardly in a second lateral direction opposite to the first lateral direction.

The knife tip preferably extends downwardly and laterally outwardly at a slope in a range of 10 to 45 degrees from vertical, and more preferably at a slope in a range of 20 to 30 degrees from vertical.

A leading edge of the knife tip may extend at an upward and rearward slope in a range of 0 to 60 degrees from vertical.

The knife tip preferably has a width in a lateral direction transverse to the forward working direction in a range of 3/8 to 3/4 of an inch.

A bottom surface of the knife tip may be sloped upwardly and rearwardly in a range 0 to 20 degrees from horizontal.

Preferably the knife tip is releasably supported on the knife body such that the knife tip is replaceable and interchangeable with other knife tips having a different lateral slope from vertical for example. The knife tip may thus be one of a plurality of different knife tip configurations which are interchangeably mounted on the knife body such the slope, depth, or thickness of the tip can be selected by the user according to current soil conditions.

According to a further aspect of the present invention there is provided a method of configuring a dual shank seeding unit for an agricultural seeding implement arranged to be operated across ground in a forward working direction in which the dual shank seeding unit includes a rear shank supporting a seed knife for forming a seed furrow for delivery of seed into the ground and a front shank spaced forwardly of the rear shank, the method comprising:

providing a fertilizer knife having (i) a fertilizer knife body including an upright leading edge spanning a majority of a height of the fertilizer knife, (ii) a fertilizer knife tip extending downwardly from a bottom end of the fertilizer knife body at a laterally outwardly slope, and (iii) a fertilizer passage having an outlet positioned rearwardly of the fertilizer knife tip so as to be arranged for depositing fertilizer therethrough; and

supporting the fertilizer knife on the front shank such that (i) the fertilizer knife tip is arranged to form a fertilizer furrow in the ground when operated in the forward working direction and (ii) a bottom end of the knife tip is offset laterally from the upright leading edge of the fertilizer knife body.

Preferably the fertilizer knife is supported on on the front shank such that the bottom end of the knife tip is offset laterally from the seed knife more than the upright leading edge of the knife body.

When the seed knife includes a seed knife tip which is sloped downwardly and laterally outwardly in a first lateral direction, the method preferably includes the supporting the fertilizer knife on the front shank such that the knife tip of the fertilizer knife is sloped downwardly and laterally outwardly in a second lateral direction opposite to the first lateral direction.

### BRIEF DESCRIPTION OF THE DRAWINGS

One embodiment of the invention will now be described in conjunction with the accompanying drawings in which:

FIG. 1 is a perspective view of a fertilizer knife according to the present invention, shown supported on a fertilizer shank of a dual shank seeding unit that also includes a seed knife of a seed shank rearward of the fertilizer shank;

FIG. 2 is a side view of the fertilizer knife and the seed knife of the dual shank seeding unit;

FIG. 3 is a top plan view of the fertilizer knife and the seed knife of the dual shank seeding unit;

FIG. 4 is a front elevational view of the fertilizer knife and the seed knife of the dual shank seeding unit;

FIG. 5 is an enlarged side elevational view of the fertilizer knife;

FIG. 6 is an exploded perspective view of the lower portion of the knife body of the fertilizer knife; and

FIG. 7 is a schematic representation of a seed furrow and a fertilizer furrow formed by the fertilizer knife and the seed knife of the dual shank seeding unit.

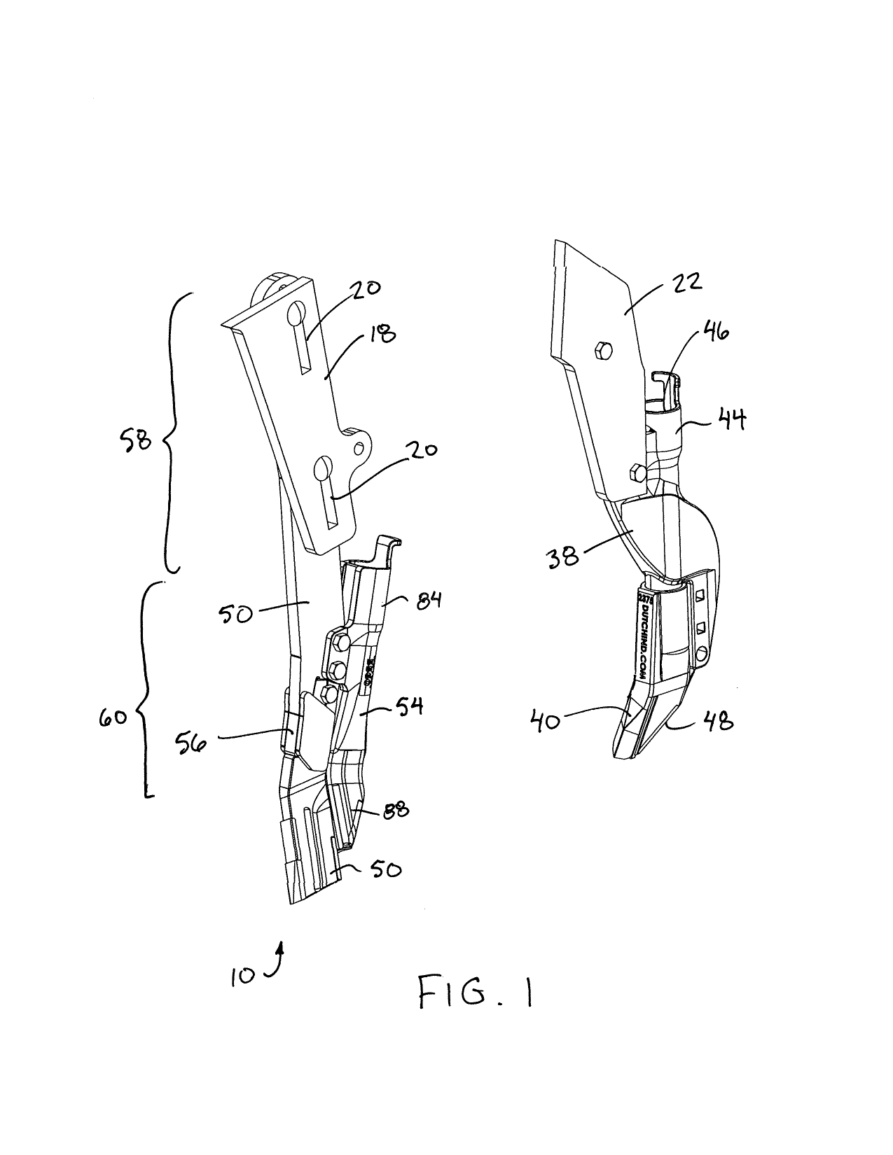

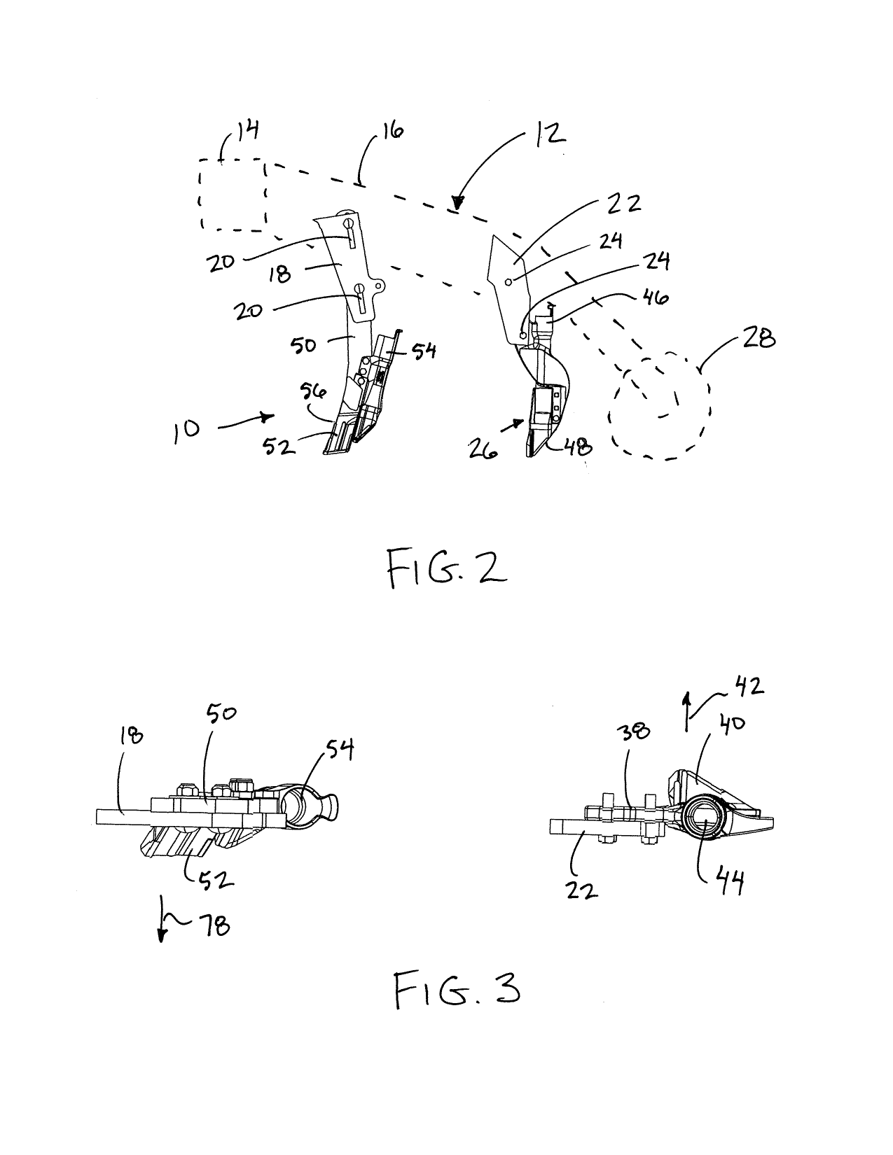

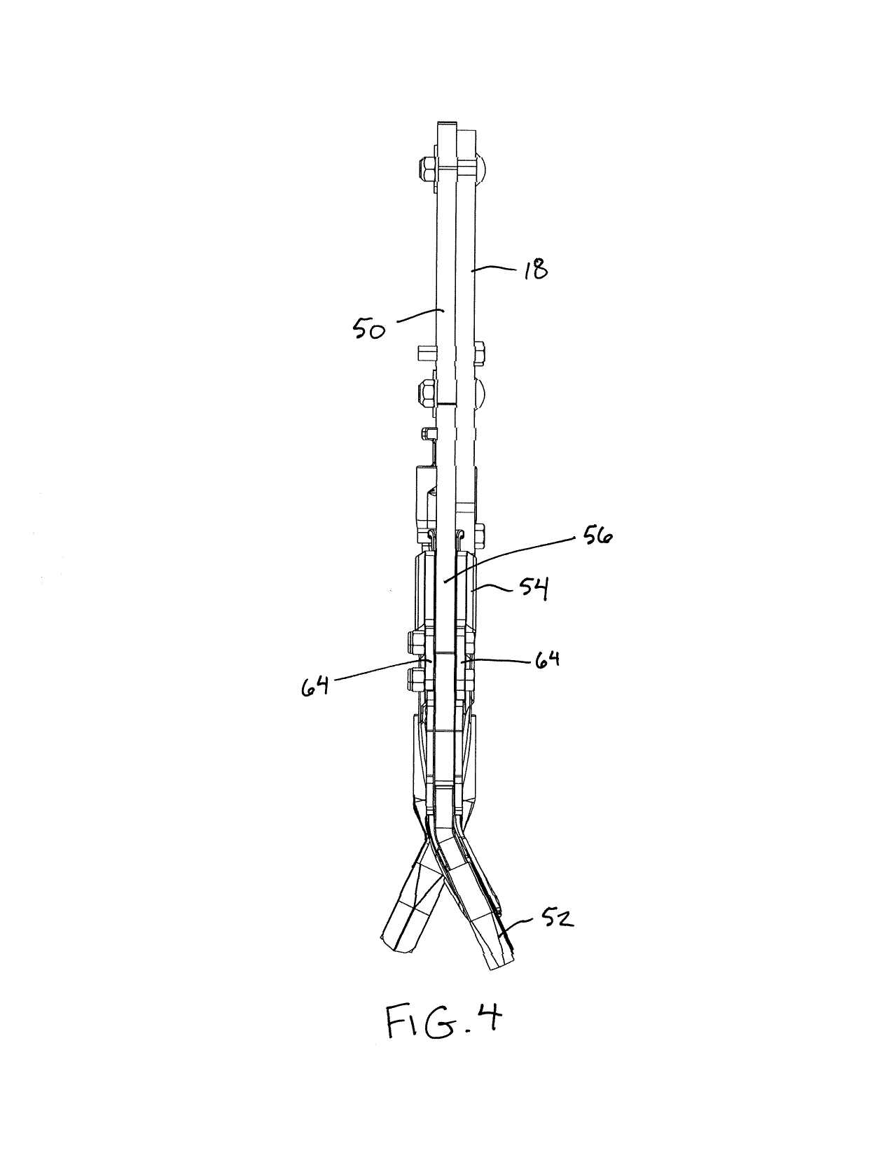

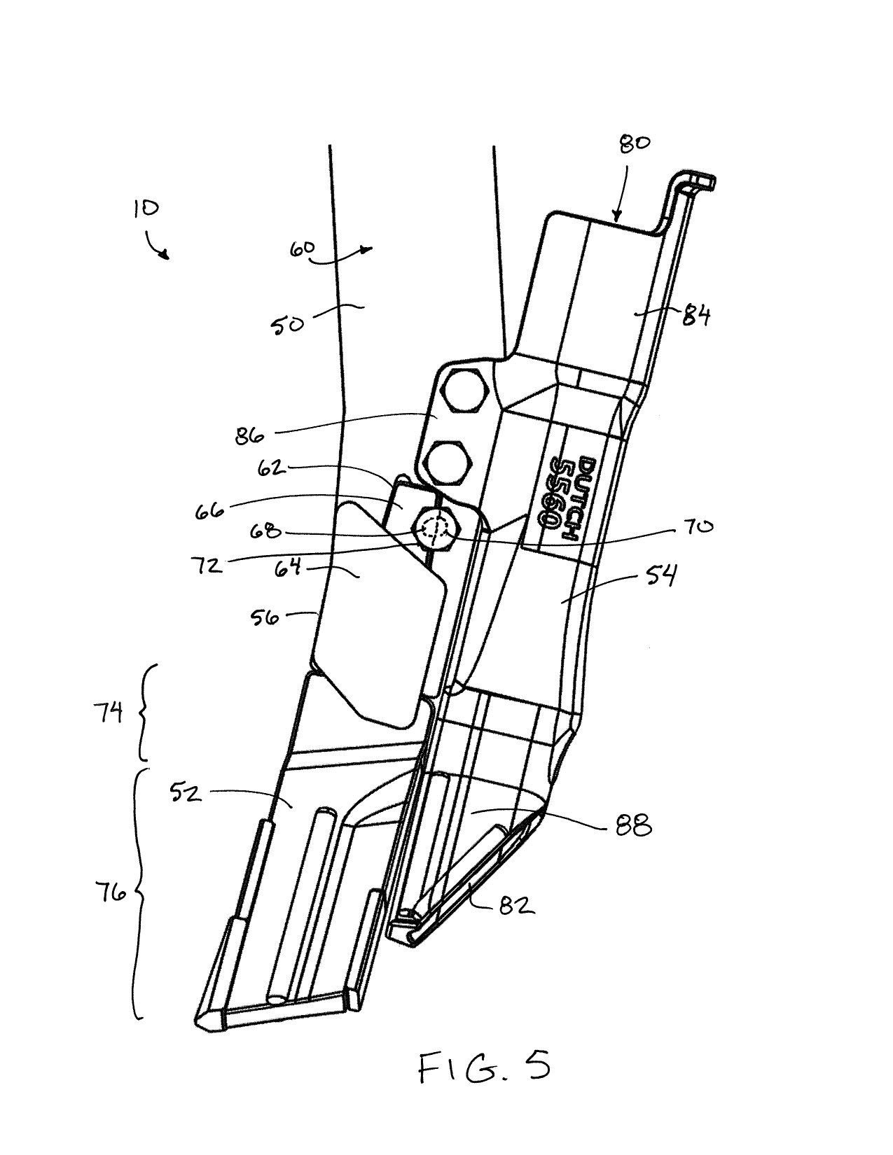

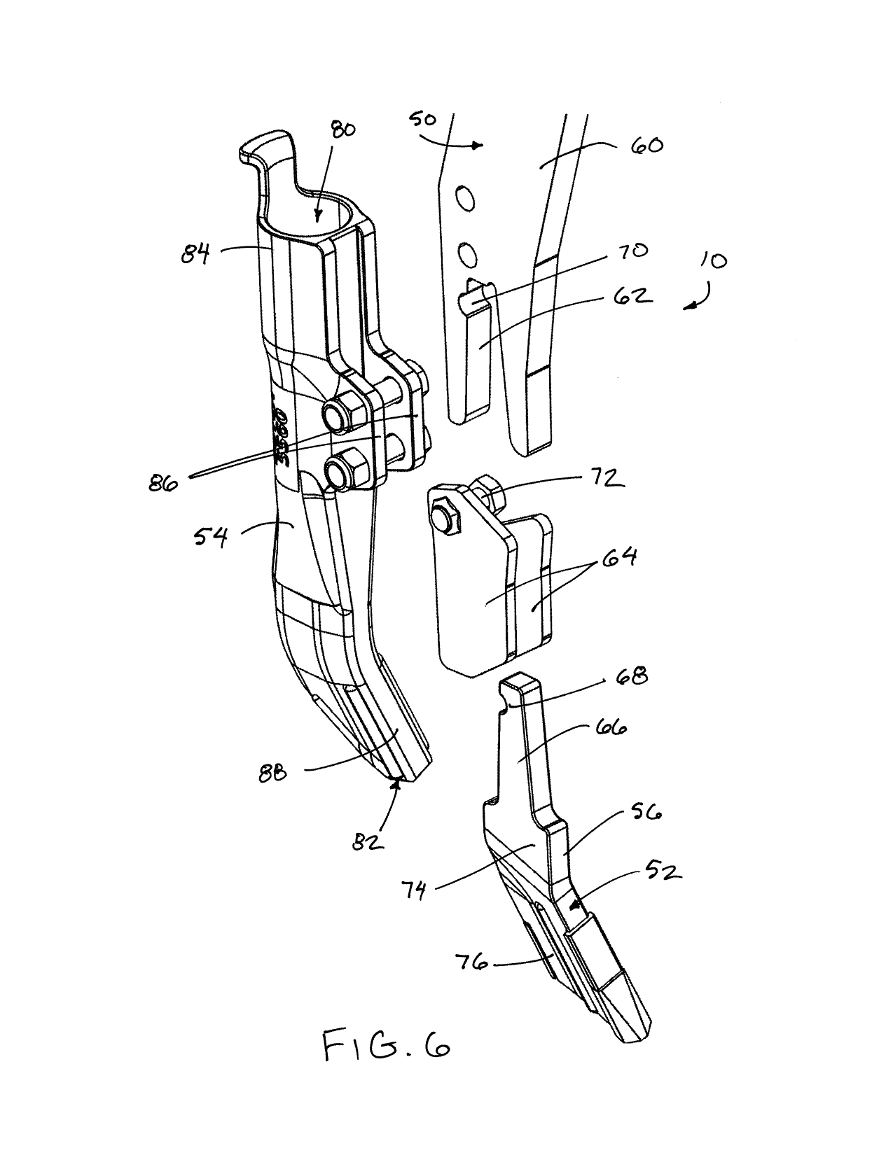

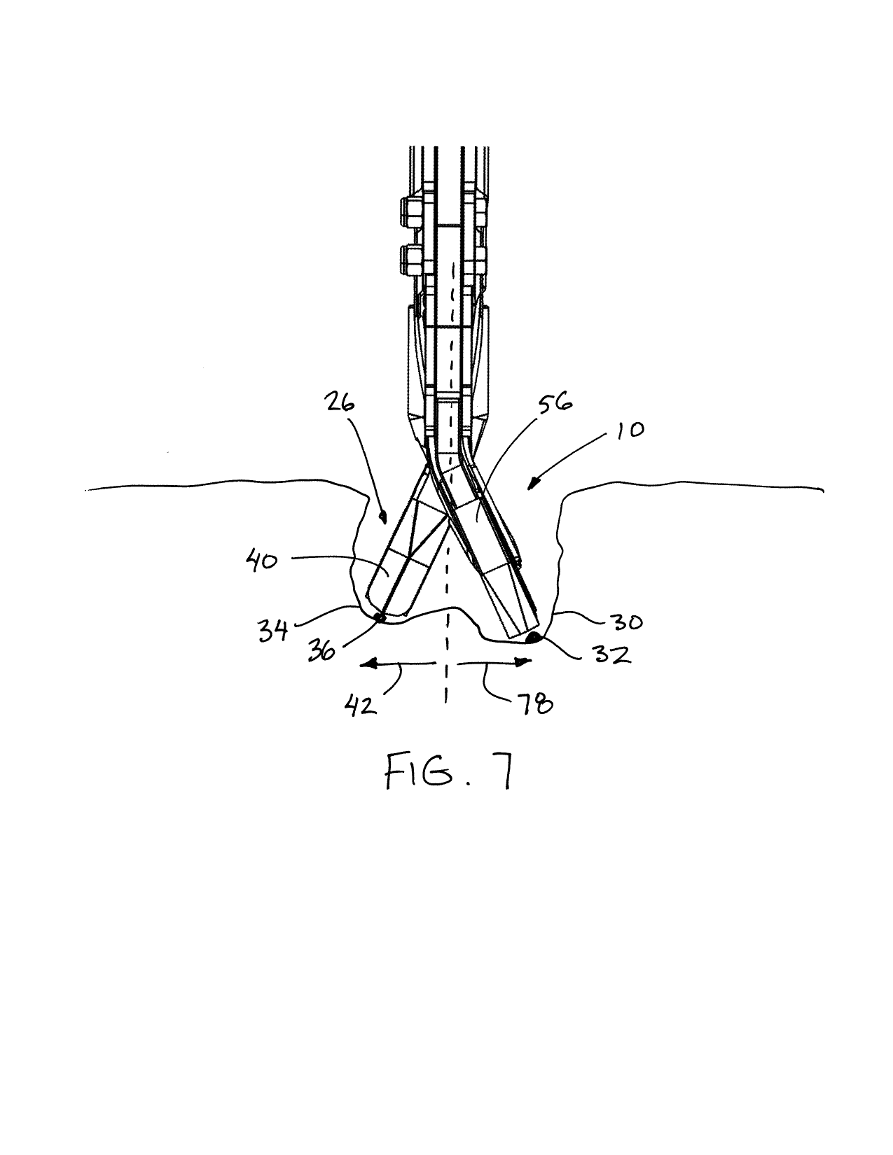

In the drawings like characters of reference indicate corresponding parts in the different figures.

### DETAILED DESCRIPTION

Referring to the accompanying figures, there is illustrated a fertilizer knife generally indicated by reference numeral 10. The fertilizer knife is particularly suited for use with a dual shank seeding unit 12 of an agricultural seeding implement (not shown) that is supported for movement across ground in a forward working direction. A typical agricultural seeding implement is connected to an agricultural tractor which tows the implement across the ground in the forward working direction. The implement may include one or more toolbars 14 extending generally horizontally in a lateral direction of the implement so as to be transverse to the forward working direction. The seeding units 12 are mounted at laterally spaced apart positions along each toolbar.

According to the illustrated embodiment, the dual shank seeding unit 12 includes a main arm 16 mounted at a forward end on the toolbar of the implement frame so that the main arm extends generally downwardly and rearwardly to an opposing trailing end of the main arm. A front shank 18 extends downwardly from the main arm 16 at an intermediate location for mounting the fertilizer knife 10 thereon. In the illustrated embodiment, the front shank is a vertical plate oriented parallel to the forward working direction with vertically spaced apart mounting apertures 20 therein for receiving fasteners used to mount the fertilizer knife 10 onto the front shank 18. The mounting apertures 20 comprise elongated slots which are vertically oriented to allow height adjustment of the fertilizer knife relative to the seeding unit.

The seeding unit 12 also includes a rear shank 22 extending downwardly from the main arm 16 at an intermediate location space rearwardly from the front shank 18. In the illustrated embodiment the rear shank is a vertical plate oriented parallel to the forward working direction so as to lie in a substantially common plane with the front shank 18 in an in-line configuration. The rear shank also includes vertically spaced apart mounting apertures 24 formed therein for mounting a seed knife 26 onto the rear shank. The seed knife 26 can be mounted directly to the rear shank or mounted to the rear shank through an intermediate conversion assembly for adjustment of the lateral spacing of the seed knife relative to the fertilizer knife.

In alternative seeding unit arrangements, the rear shank 22 may be offset laterally from the front shank 18.

The main arm 16 further comprises a packing wheel 28 supported at the trailing end for rolling engagement on the ground in the forward working direction. In this arrangement, as represented schematically in FIG. 7, the fertilizer knife 10 on the front shank 18 forms a fertilizer furrow 30 in the ground into which fertilizer 32 is deposited when the implement is operated in the forward working direction. Meanwhile, the seed knife 26 forms a seed furrow 34 in the ground alongside the fertilizer furrow into which seed 36 is deposited when the implement is operated in the forward working direction. The packing wheel 26 serves to close the furrows. Each of the front shank 18, the rear shank 22 and the packing wheel 28 may be resiliently supported or adjustably suspended relative to the implement frame and/or relative to one another.

According to the illustrated embodiment, the seed knife 26 includes a seed knife body 38 spanning a majority of a height of the seed knife so as to define a longitudinal axis of the seed knife which is near vertical in orientation. An upper end of the seed knife body includes spaced apart fastener apertures formed therein for fastening the seed knife body to the spaced apart apertures 24 of the rear shank 22 using suitable threaded fasteners. A seed tip 40 extends downwardly from the bottom end of the seed knife body at a downward and laterally outward slope, for example between 20 and 30 degrees from vertical such that the bottom end of the seed tip is spaced laterally outwardly from the upright leading edge of the seed knife body 38 in a first lateral direction 42, away from the upright leading edge of the fertilizer knife as described in further detail below. A tubular seed passage 44 extends through the seed knife body 38 from an inlet opening 46 positioned rearwardly of the seed knife body 38 adjacent the rear shank 22 to an outlet opening 48 positioned rearwardly of the seed tip 40 through which seed is deposited into the seed furrow formed by the seed tip in operation. The inlet opening 46 is configured for attachment to a pneumatic seed delivery hose of the seeding implement.

The fertilizer knife 10 according to the present invention generally includes (i) a fertilizer knife body 50 for mounting onto the front shank 18, (ii) a fertilizer knife tip 52 extending from the bottom end of the knife body 50 for forming the fertilizer furrow 30, and (iii) a fertilizer tube 54 defining a fertilizer passage extending therethrough for depositing the fertilizer 32 into the fertilizer furrow 30.

The fertilizer knife body 50 is an upright flat plate lying in a vertical plane parallel to the forward working direction such that a front edge of the plate defines an upright leading edge 56 of the knife body that spans a majority of the overall height of the fertilizer knife 10. The width of the plate which defines the width of the upright leading edge is typically in the range of 3/8 to 3/4 of an inch. An upper portion 58 of the plate includes spaced apart mounting apertures formed therein for alignment with the mounting apertures 20 of the front shank to receive threaded fasteners that mount the knife body 50 in fixed relation to the front shank.

A lower portion 60 of the knife body extends below the front shank and serves to support the fertilizer knife tip 52 releasably thereon. The leading edge along the upright portion 58 may be near vertical in orientation, whereas the leading edge along the lower portion 60 is sloped upwardly and rearwardly from the fertilizer tip 52 at a similar slope as the leading edge of the fertilizer tip. The lower portion 60 of the knife body 50 defines a socket 62 therein which is open to the bottom of the knife body. The socket 62 is formed by a recess occupying a full thickness of the plate forming the knife body while being enclosed at laterally opposing sides by a pair of side plates 64 fixedly mounted to the laterally opposing sides of the plate forming the knife body, for example by welding.

The tip 52 includes an upper mounting portion 66 in the form of a stem that is shaped and sized to mate into the socket 62 of the knife body 50. The stem is tapered upwardly similar to the shape of the socket for ease in vertically sliding of the stem upwardly into the open bottom end of the socket when mounting the fertilizer tip 52 onto the bottom end of the knife body 50. A catch 68 is provided for selectively retaining the tip on the knife body in the form of a groove or semicircular recess formed in the rear edge of the stem that is aligned with a corresponding groove or recess 70 formed in the rear edge of the socket 62 when the upper mounting portion 66 is fully received within the socket 62 in the mounted position. A transverse retainer bolt 72 extends through the aligned catch 68 and recess 70 to prevent removal of the tip from the knife body while the bolt 72 remains in place.

A main body of the tip 52 includes an upper portion 74 which is flat and substantially vertically oriented similarly to the plate forming the knife body 50 so as to extend substantially continuously from the knife body with a leading edge being continuous with the leading edge of the knife body 50 so as to lie in a vertical plane while being sloped upwardly and rearwardly.

A lower portion 76 of the tip extends downward from the upper portion 74 at a downward and laterally outward slope in a second lateral direction 78 that is opposite to the first lateral direction 42 of the seed knife offset described above. The lower portion 76 of the tip also generally takes the form of a flat plate having a thickness in the lateral direction between 3/8 and 3/4 of an inch such that a front edge of the plate defines the leading edge of the tip. The leading edge of the tip is continuous with the leading edge of the knife body so as to be sloped upwardly and rearwardly at the same slope as the upper portion 74 of the tip and the lower portion 60 of the knife body.

The leading edges may be sloped upwardly and rearwardly at a slope in the range of 0 to 60 degrees from vertical, but is more preferably in a range of 10 to 40 degrees from vertical. In the illustrated embodiment, the upright edges are sloped at approximately 20 degrees from vertical.

The lower portion 76 of the tip is preferably sloped downwardly and laterally outwardly in the second lateral direction 78 at a slope in a range of 10 to 45 degrees from vertical, but is more preferably in a range of 20 to 30 degrees from vertical. In the illustrated embodiment, the lower portion is sloped laterally at approximately 25 degrees from vertical. This results in the bottom end of the tip 52 being offset in the lateral direction and a range of 1 to 2 inches from the upright leading edge of the knife body 50, and ideally near 1.5 inches from the upright leading edge of the knife body.

A bottom surface of the tip is generally flat and perpendicular to the laterally opposing sidewalls of the tip, while being sloped upwardly and rearwardly in a range of 0 to 20 degrees from horizontal.

The fertilizer tube 54 of the fertilizer knife extends along a rear edge of the knife body between an inlet 80 at a top end which is spaced above the tip 52 so as to be in proximity to the bottom end of the front shank, and an outlet 82 which is positioned rearwardly of the tip so as to be laterally offset in the second lateral direction 78 from the upright leading edge of the knife body 58 similarly to the bottom end of the fertilizer knife tip 52. An upper portion of the fertilizer tube adjacent the inlet 80 is generally circular in cross-section having an overall width that is wider than the knife body 50 with a suitable bracket portion 84 configured for attachment to a pneumatic fertilizer delivery hose of the seeding implement to receive fertilizer therein from the distribution system of the implement.

A mounting portion of the fertilizer tube is defined by a pair of parallel plates 86 which protrude forwardly from the fertilizer tube at an intermediate height along the tube. The plates 86 are spaced apart laterally by a thickness of the plate defining the knife body 50 so as to receive a rear edge of the knife body inserted between the parallel plates when mounting the fertilizer tube onto the knife body. Fastener apertures extend through the parallel plates 86 and the knife body to receive mounting fasteners therethrough that selectively retain the fertilizer tube mounted rearwardly of the knife body.

A lower portion of the fertilizer tube is tapered to be narrower in width such that the lower portion has a width corresponding to the width of the tip 52. A bottom end portion 88 of the fertilizer tube follows the same downward and laterally outward slope in the second lateral direction 78 as the lower portion 76 of the tip so that the outlet at the bottom end of the end portion 88 is aligned rearwardly of the bottom end of the tip.

As described herein, when the seed knife is a bent knife having a tip offset in a first lateral direction 42 according to the illustrated embodiment, the fertilizer tip 52 of the fertilizer knife is offset laterally in an opposing second lateral direction 78 such that the tip is spaced laterally from the tip of the seed knife by a greater lateral distance than the upright leading edge of the fertilizer knife. This increases the separation distance between the seed and fertilizer while maintaining the fertilizer knife body and the seed knife body on respective shanks which are inline with one another to minimize soil disturbance and trash collection on the shanks.

In other embodiments, when the seed shank and the fertilizer shank are offset laterally from one another to provide some offset between the tip of the seed knife relative to the upright leading edge of the knife body, the fertilizer knife 10 according to the present invention is again configured so that the tip of the fertilizer knife is offset in a lateral direction that positions the fertilizer outlet farther from the tip of the seed knife than the upright leading edge of the fertilizer knife. Again, this increases the separation between the seed and the fertilizer while maintaining the same relative positioning of the fertilizer knife body and the seed knife body so as not to affect soil disturbance or trash collection on the shanks.

In some arrangements, the fertilizer tip may be provided as a system of a plurality of fertilizer different tips having lower portions which are sloped downwardly and laterally outwardly at different slopes and possibly different heights so as to vary the spacing of the fertilizer outlet from the upright leading edge of the fertilizer knife body and from the tip of the seed knife. The operator can select which fertilizer tip is expected to perform best based on the current soil conditions and then configures the seeding unit by mounting the tip on the seeding unit in a manner that maximizes the distance of the fertilizer from the seed by offsetting the fertilizer tip away from the tip of the seed knife.

Since various modifications can be made in the invention as herein above described, and many apparently widely different embodiments of same made, it is intended that all matter contained in the accompanying specification shall be interpreted as illustrative only and not in a limiting sense.

1. A fertilizer knife for a dual shank seeding unit of an agricultural seeding implement operated across ground in a forward working direction in which the dual shank seeding unit includes a rear shank supporting a seed knife for delivery of seed into the ground and a front shank spaced forwardly of the rear shank, the fertilizer knife comprising:
a knife body arranged for mounting onto the front shank, the knife body including an upright leading edge spanning a majority of a height of the fertilizer knife;
a knife tip extending downwardly from a bottom end of the knife body so as to be arranged to form a fertilizer furrow in the ground when operated in the forward working direction; and
a fertilizer passage having an outlet positioned rearwardly of the knife tip so as to be arranged for depositing fertilizer therethrough into the fertilizer furrow in the ground;
wherein the knife tip extends downwardly from the knife body at a laterally outwardly slope such that a bottom end of the knife tip is offset laterally from the upright leading edge of the knife body.

2. The fertilizer knife according to claim 1 wherein the bottom end of the knife tip is arranged to be offset laterally from the seed knife more than the upright leading edge of the knife body.

3. The fertilizer knife according to claim 1 wherein the knife tip extends downwardly and laterally outwardly at a slope in a range of 10 to 45 degrees from vertical.

4. The fertilizer knife according to claim 1 wherein the knife tip extends downwardly and laterally outwardly at a slope in a range of 20 to 30 degrees from vertical.

5. The fertilizer knife according to claim 1 wherein a leading edge of the knife tip extends at an upward and rearward slope in a range of 0 to 60 degrees from vertical.

6. The fertilizer knife according to claim 1 wherein the knife tip has a width in a lateral direction transverse to the forward working direction in a range of 3/8 to 3/4 of an inch.

7. The fertilizer knife according to claim 1 wherein a bottom surface of the knife tip is sloped upwardly and rearwardly in a range 0 to 20 degrees from horizontal.

8. The fertilizer knife according to claim 1 wherein the seed knife includes a seed knife tip which is sloped downwardly and laterally outwardly in a first lateral direction and wherein the knife tip of the fertilizer knife is sloped downwardly and laterally outwardly in a second lateral direction opposite to the first lateral direction.

9. The fertilizer knife according to claim 1 wherein the knife tip is releasably supported on the knife body.

10. A dual shank seeding unit for an agricultural seeding implement arranged to be operated across ground in a forward working direction, the dual shank seeding unit comprising:
a rear shank arranged to be supported on the implement;
a seed knife supported on the rear shank including (i) a seed knife body for forming a seed furrow in the ground when operated in the forward working direction and (ii) a seed passage having an outlet positioned rearwardly of the seed knife tip for depositing seed therethrough into the seed furrow in the ground;
a front shank arranged to be supported on the implement at a location spaced forwardly of the rear shank; and
a fertilizer knife comprising (i) a fertilizer knife body supported on the front shank and including an upright leading edge spanning a majority of a height of the fertilizer knife, (ii) a fertilizer knife tip extending downwardly from a bottom end of the fertilizer knife body so as to be arranged to form a fertilizer furrow in the ground when operated in the forward working direction, and (iii) a fertilizer passage having an outlet positioned rearwardly of the fertilizer knife tip so as to be arranged for depositing fertilizer therethrough into the fertilizer furrow in the ground;
wherein the fertilizer knife tip extends downwardly from the fertilizer knife body at a laterally outwardly slope such that a bottom end of the knife tip is offset laterally from the upright leading edge of the fertilizer knife body.

11. The dual shank seeding unit according to claim 10 wherein the bottom end of the fertilizer knife tip is arranged to be offset laterally from the seed knife more than the upright leading edge of the fertilizer knife body.

12. The dual shank seeding unit according to claim 10 wherein the seed knife includes a seed knife tip which is sloped downwardly and laterally outwardly in a first lateral direction and wherein the fertilizer knife tip is sloped downwardly and laterally outwardly in a second lateral direction opposite to the first lateral direction.

13. A method of configuring a dual shank seeding unit for an agricultural seeding implement arranged to be operated across ground in a forward working direction in which the dual shank seeding unit includes a rear shank supporting a seed knife for forming a seed furrow for delivery of seed into the ground and a front shank spaced forwardly of the rear shank, the method comprising:
providing a fertilizer knife having (i) a fertilizer knife body including an upright leading edge spanning a majority of a height of the fertilizer knife, (ii) a fertilizer knife tip extending downwardly from a bottom end of the fertilizer knife body at a laterally outwardly slope, and (iii) a fertilizer passage having an outlet positioned rearwardly of the fertilizer knife tip so as to be arranged for depositing fertilizer therethrough; and
supporting the fertilizer knife on the front shank such that (i) the fertilizer knife tip is arranged to form a fertilizer furrow in the ground when operated in the forward working direction and (ii) a bottom end of the knife tip is offset laterally from the upright leading edge of the fertilizer knife body.

14. The method according to claim 13 including supporting the fertilizer knife on the front shank such that the bottom end of the knife tip is offset laterally from the seed knife more than the upright leading edge of the knife body.

15. The method according to claim 13 wherein the knife tip extends downwardly and laterally outwardly at a slope in a range of 10 to 45 degrees from vertical.

16. The method according to claim 13 wherein the knife tip extends downwardly and laterally outwardly at a slope in a range of 20 to 30 degrees from vertical.

17. The method according to claim 13 wherein a leading edge of the knife tip extends at an upward and rearward slope in a range of 0 to 60 degrees from vertical.

18. The method according to claim 13 wherein the knife tip has a width in a lateral direction transverse to the forward working direction in a range of 3/8 to 3/4 of an inch.

19. The method according to claim 13 wherein a bottom surface of the knife tip is sloped upwardly and rearwardly in a range 0 to 20 degrees from horizontal.

20. The method according to claim 13 wherein the seed knife includes a seed knife tip which is sloped downwardly and laterally outwardly in a first lateral direction and wherein the method includes the supporting the fertilizer knife on the front shank such that the knife tip of the fertilizer knife is sloped downwardly and laterally outwardly in a second lateral direction opposite to the first lateral direction.
